(19) United States
(12) Patent Application Publication
(10) Pub. No.: US 2016/0232609 A1
(43) Pub. Date: Aug. 11, 2016

(54) MOBILE SYSTEM FOR EXCHANGING GIFT CARDS

(71) Applicant: Outerwall Inc., Bellevue, WA (US)

(72) Inventors: Elizabeth Larrick Lindemulder, Chicago, IL (US); Jason Friedlander, Highlands Ranch, CO (US)

(21) Appl. No.: 14/617,672

(22) Filed: Feb. 9, 2015

(51) Int. Cl. G06Q 40/04; G06Q 20/34

(52) U.S. Cl. CPC G06Q 40/04; G06Q 20/342

(57) ABSTRACT

The present disclosure is directed a mobile computing device that is programmed to communicate with a gift card exchange server that allows a user to exchange gift cards for consideration from a remote location. The mobile computing device is configured to receive information about a gift card from a user and to transmit the information to the gift card exchange server. The gift card exchange server determines an offer for the gift card and transmits it to the mobile computing device for presentation to the user. In one embodiment, if the offer is accepted, the user is prompted to provide personal identifying information. In order to reduce fraud, the gift card exchange server also requests device specific identifying information that is unique to the mobile computing device itself and associates the device specific identifying information with the offer. In order to redeem funds, the user is asked to present the personal identifying information and the mobile device having the device specific mobile identifying information that is associated with the offer before they can be paid. The particular device specific identifying information requested may vary from transaction to transaction.

### CROSS-REFERENCE TO APPLICATION(S) INCORPORATED BY REFERENCE

The disclosures of U.S. patent application Ser. No. 11/294,637, titled “METHODS AND SYSTEMS FOR EXCHANGING AND/OR TRANSFERRING VARIOUS FORMS OF VALUE,” filed Dec. 5, 2005; U.S. patent application Ser. No. 10/558,907, titled “METHODS AND SYSTEMS FOR PROVIDING PRODUCTS, SUCH AS DIGITAL CONTENT INCLUDING GAMES, RING TONES, AND/OR GRAPHICS; AND SERVICES, SUCH AS COMPUTER NETWORK SERVICE INCLUDING INTERNET SERVICE,” filed Feb. 7, 2007; U.S. Pat. No. 8,332,313, titled “METHODS AND SYSTEMS FOR EXCHANGING AND/OR TRANSFERRING VARIOUS FORMS OF VALUE,” filed Jul. 22, 2008; U.S. Pat. No. 8,024,272, titled “METHODS AND SYSTEMS FOR EXCHANGING/TRANSFERRING GIFT CARDS,” filed Apr. 12, 2010; U.S. Pat. No. 8,229,851, titled “METHODS AND SYSTEMS FOR EXCHANGING/TRANSFERRING GIFT CARDS,” filed Aug. 19, 2011; U.S. patent application Ser. No. 13/286,971, titled “GIFT CARD EXCHANGE KIOSKS AND ASSOCIATED METHODS OF USE,” filed Nov. 1, 2011 and U.S. Provisional Patent Application No. 61/970,809, titled “PREPAID CARD EXCHANGE SYSTEMS AND ASSOCIATED METHODS,” filed Mar. 26, 2014, which are incorporated herein by reference in their entireties.

### TECHNICAL FIELD

The present disclosure relates generally to systems, apparatuses, and methods for exchanging gift cards and, more particularly, to mobile platforms for exchanging gift cards for cash, cash vouchers, other gift cards, etc.

### BACKGROUND

Gift cards and other prepaid cards are restricted monetary equivalents issued by retailers or banks that consumers can use as an alternative to currency for purchasing goods, services, etc. While prepaid cards rank as one of the most popular gifts given by consumers in the United States, an estimated $8 billion worth of unused and/or expired gift card value, referred to as “breakage,” occurs annually. Various methods have been proposed to reduce breakage. Some websites, for example, provide consumers with the ability to sell unwanted gift cards by auction. Other websites provide consumers with the ability to exchange unwanted gift cards for cash through the mail. Additionally, kiosks, such as those operated Outerwall, Inc., the assignee of the present application, allow consumers to exchange gift cards for a cash voucher that can be exchanged for cash or used to purchase goods at a participating retailer. While such kiosks offer a convenient way to exchange gift cards for cash or other items of monetary value, the owner of the gift card must usually be present at the kiosk to conduct the transaction. There is therefore a need to enable users to exchange gift cards without having to physically visit a kiosk in order to conduct the entire transaction, while simultaneously protecting the operator of the exchange system against fraud.

One of the most common sources of fraud in the gift card exchange business model is referred to as “double dipping.” For example, an unscrupulous cardholder could write down the identification number associated with a $100 gift card, and then exchange the card for a cash voucher using, e.g., a gift card exchange kiosk. The cardholder could then redeem the $100 card value (e.g., by using the copied identification number to make for example, an online purchase) before the card has been resold or otherwise monetized by the kiosk operator. Accordingly, it would be advantageous to provide a financially secure gift card exchange system that prevents unscrupulous consumers from misappropriating card value while still providing the user the ability to exchange cards without physically visiting the kiosk.

### BRIEF DESCRIPTION OF THE DRAWINGS

FIG. 1 illustrates a system for facilitating the exchange of gift cards with a mobile computing device in accordance with one embodiment of the present disclosure.

FIG. 2 illustrates a representative user interface screen on a mobile computing device that allows a user to begin a process of exchanging a gift card in accordance with one embodiment of the present disclosure.

FIG. 3 illustrates a representative user interface screen on a mobile computing device that allows a user to submit information for a gift card in order to receive an offer for the card in accordance with one embodiment of the present disclosure.

FIG. 4 illustrates a representative user interface screen on a mobile computing device that allows a user to capture an image of a gift card in accordance with one embodiment of the present disclosure.

FIG. 5 illustrates a representative user interface screen on a mobile computing device that allows a user to accept or decline an offer for a gift card in accordance with one embodiment of the present disclosure.

FIG. 6 illustrates a representative user interface screen on a mobile computing device that allows a user to view one or more offers in a shopping cart for checkout or further shopping and/or editing in accordance with one embodiment of the present disclosure.

FIG. 7 illustrates a representative user interface screen on a mobile computing device that allows a user to have funds transferred electronically in exchange for a gift card in accordance with one embodiment of the present disclosure.

FIG. 8 illustrates a representative user interface screen on a mobile computing device that allows a user to receive a code or voucher for obtaining payment from a kiosk or other device in exchange for a gift card in accordance with one embodiment of the present disclosure.

FIG. 9 illustrates a representative user interface screen on a mobile computing device that allows a user view nearby kiosks in accordance with one embodiment of the present disclosure.

FIG. 10 illustrates a representative user interface screen on a mobile computing device that allows a user to log into an account with a gift card exchange service in accordance with one embodiment of the present disclosure.

FIG. 11 illustrates a representative user interface screen on a mobile computing device that allows a user to sign up for an account with a gift card exchange service in accordance with one embodiment of the present disclosure.

FIG. 12 illustrates a representative user interface screen on a mobile computing device that allows a user to edit personal identifying information associated with an account of a gift card exchange service in accordance with one embodiment of the present disclosure.

FIG. 13 illustrates a representative user interface screen on a mobile computing device that allows a user to edit address information associated with an account of a gift card exchange service in accordance with one embodiment of the present disclosure.

FIG. 14 illustrates a representative user interface screen on a mobile computing device that allows a user to edit credit card information associated with an account of a gift card exchange service in accordance with one embodiment of the present disclosure.

FIG. 15 illustrates a representative user interface screen on a mobile computing device that allows a user to obtain information about a gift card exchange service in accordance with one embodiment of the present disclosure.

FIG. 16 is a flow chart of steps performed by an exchange server computer interacting with a mobile computing device and in order to allow a user to exchange a gift card without being present at a kiosk in accordance with one embodiment of the present disclosure.

### DETAILED DESCRIPTION

The present disclosure describes various embodiments of systems and methods for exchanging various types of prepaid cards (e.g., gift cards), gift card facsimiles, and similar financial instruments (herein referred to as “gift cards” unless indicated otherwise) for cash, a cash voucher, another gift card etc. Such methods and systems can include, for example, ways for consumers to monetize their unused or unwanted gift cards using their smart phones and/or other mobile electronic devices.

As indicated above, the term “gift card” can generally refer to a “financial instrument” that may resemble a credit card, a card facsimile, a voucher, etc., or an electronic equivalent of these things, and has a monetary value (i.e., a face value or balance value). A gift card typically includes a gift card identifier (e.g., an alphanumeric code) that is cross-linked to the gift card's balance. Gift cards can include barcodes, magnetic stripes, processors (e.g., smart chips), optical media, and/or other media for recording gift card identifiers, codes, values, and/or other suitable information. As used herein, the term “gift card” can also encompass virtual gift cards that can be delivered via email, text messages, or mobile phone applications (e.g., iPhone applications) and displayed using a smart phone, tablet, and/or other suitable devices. Gift cards may be open loop or closed loop cards. Banks or credit card companies can issue open loop cards that can be redeemed at different commercial establishments. Conversely, restaurants, stores, and other retail establishments generally issue closed loop cards that are valid only for use at the retail establishment or its retail partners. Accordingly, although the term “gift card” may be used herein for ease of reference, the term will be understood to include other financial instruments unless the context dictates otherwise

In accordance with one or more embodiments of the present disclosure, a computer system associated with a gift card exchange service can receive information about a gift card and/or gift card identifier from a consumer wishing to exchange the gift card, verify the gift card's activation status and value, and provide exchange options to a consumer. The options can include, for example, exchanging the gift card for a cash voucher, cash, another gift card of, e.g., a different brand or a same brand and/or a different retailer or same retailer, and/or other types of remuneration or cash equivalent (e.g. bitcoins), cryptographic currencies, credit, payment to reduce a credit card balance or other loan balance, etc. After receiving the gift card information from the consumer and authorizing payment in the desired form in exchange for the card, the exchange service can update a gift card database to reflect the exchange and resell the gift card or the gift card value to another consumer or service via, e.g., an online or electronic marketplace (e.g., a website) or other marketplace.

As discussed above, in currently available implementations of gift card exchange services, a user has to physically present the gift card that they wish to exchange at a kiosk or submit the card identifier to an on-line gift card exchange service. Such a purchaser could be a live agent of the service but is more likely a kiosk that is programmed to read the card and present the owner an offer. While the kiosk system works well, the system does not give the user the ability to exchange cards from any location. To address this problem, the disclosed technology provides a system where a user can provide gift card information to a gift card exchange service using a mobile computing device at any location where the mobile computing device can establish a communication connection with the gift card change service. In one embodiment, the mobile computing device is a smart phone. However, it will be appreciated that other mobile computing devices could be used, such as tablet computers (e.g. Apple iPad, Microsoft Surface etc.), laptop computers, smart watches, personal digital assistants (PDAs) or other devices that can run an application program and include a mechanism for entering gift card information, such as a touch screen, keyboard, camera, voice recognition software or the like.

As will be described in further detail below, the mobile computing device establishes a communication link with the gift card exchange service via a wireless communication link (e.g. a cellular or satellite communication link, WiFi, WiMax or the like), or via a wired communication link (e.g. a hard-wired network or communication connection). For illustrative purposes, the mobile computing device is described as a smart phone. However, the scope of the technology is not so limited.

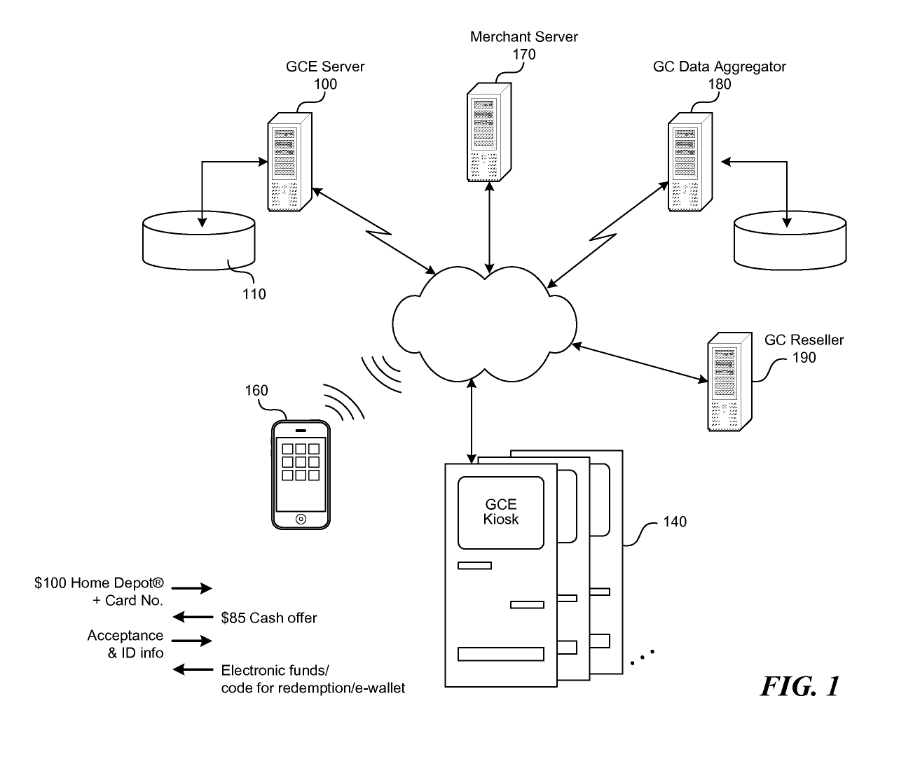

FIG. 1 shows a representative system for allowing a user to exchange a gift card using a mobile computing device. A gift card exchange server computer 100 is coupled to a communication link, such as the Internet, so that it can communicate with other remotely located electronic devices. The server computer 100 is programmed to receive gift card identifying information, such as the issuer of the gift card, the card number or other identifying information, and the card value. The sever computer is also programmed to provide an offer for the card and to initiate the transfer of value if the offer is accepted. In addition, the sever computer 100 keeps a record of gift cards that were exchanged and the prices paid for the cards in a database 110.

In the example shown, the gift card exchange server computer 100 is programmed to communicate with a number of kiosks 140 at which customers can exchange gift cards for value. The server computer 100 interacts with the kiosks 140 to obtain information about the gift cards that were purchased from users as well as the prices paid, for storage in the database 110. In this way, the server computer 100 can operate to cancel or otherwise disable the card numbers associated with the purchased cards so that it is less likely that a seller of the card will be able to use the card number to make other purchases with the card number or sell the card to another party. Methods for disabling a card number can include those described in U.S. Provisional Application No. 61/970,809, which is incorporated by reference in its entirety.

In accordance with one embodiment of the disclosed technology, the server computer 100 receives communications from a remotely located, mobile computing device such as a user's smart phone 160. The user has loaded application software onto their smart phone 160 that allows the user to enter information about gift cards that the user wishes to exchange in order to receive an offer for such cards. The user can download the application software from an application store or a website associated with the gift card exchange server 100.

Upon activating the application software on their smart phone, the user is prompted to provide information about any gift cards they wish to exchange. Such information can include the card issuer, the card value, the card numbers etc. and can be provided by typing such information onto a user interface screen of the phone. Alternatively, the user can capture an image of the gift card (e.g. the gift card number) using a built-in camera on the phone. The information is sent via the communication link to the gift card exchange server 100 in order to solicit an offer for the value of the card.

As an example, assume that a user has a $100 gift card from the Home Depot® but doesn't have a need for any home building products. The user enters information for the card into their smart phone and the application software transmits the information to the gift card exchange server 100. The gift card exchange server 100 verifies the value of the card either by checking to see if the card number is stored in its database 110 or by communicating with the merchant 170 who initially sold the card or a third party gift card data aggregator 180 that keeps records of gift cards that have been exchanged and their value etc. The gift card number is checked to confirm what the value remaining on the card is and that the value hasn't already been spent by the user or otherwise exhausted by the user.

Assuming that the card is still worth its full face value, the gift card exchange server 100 determines an offer for the card and transmits the offer back to the smart phone 160. In the example shown, an offer of $85 cash is made for the $100 gift card. The user then interacts with the application (via e.g. the keypad or touch screen on the smart phone 160) to either accept or reject the offer. If the offer is rejected, the transaction ends.

If the offer is accepted, the user is prompted to provide confirmation of their identity (e.g. personal ID information). Such information could be a driver's license number, passport information, biometric information (thumb print, retina scan or the like) etc. The acceptance and the personal ID information are sent back to the exchange server 100 which begins processing the transaction. In one embodiment, the gift card exchange server checks the received personal ID information to see if the user is on a “banned” or “blocked customer” list. If so, the transaction is halted. If the user is not on the banned customer list, the user is asked if they would like to receive the funds electronically. If so, the user is asked to provide an account number (such as a PayPal account or banking or e-wallet number, credit card number etc.) that indicates where the funds are to be applied. The gift card exchange server then initiates the transfer of money to the indicated account via e.g. a remote clearing house and/or money transfer network. After the money is sent, the gift card exchange server takes steps to ensure that the gift card number for the card purchased is no longer usable or is otherwise identified as having been sold.

In one embodiment, the gift card exchange server 100 begins a “drain and re-issue” process as described in U.S. Provisional Application No. 61/970,809, filed Mar. 26, 2014, which was incorporated by reference above. In another embodiment, the gift card exchange server sends information to a gift card data aggregator 180 that stores information for many cards, including whether a particular card number has been sold to the gift card exchange and is no longer available for use in purchasing goods or services. As will be appreciated, there are numerous other ways of preventing the user from attempting to re-use the card number that they have sold to the gift card exchange service.

If the user does not want their funds to be transferred electronically, then the gift card exchange server 100 transmits a voucher, such as code (e.g. numeric, alpha-numeric, bar code, QR code) photographic or graphic image, or other such code to the mobile device. The code can be presented by the user to one of the kiosks 140 (via e.g. a kiosk touch screen or other interface, optical sensors or scanners, near field communications with a mobile computing device, etc.) or other related machines (e.g. a Coinstar® coin counting machine) or a point of sale (POS) device at a participating merchant to redeem the voucher for cash or other items of value.

In one embodiment of the technology, the application software on the smart phone is programmed to send device specific identifying information about the smart phone or other mobile computing device along with the personal ID information to further identify the user. For example, the application software may send the international mobile equipment identifier (IMEI) number of the phone, its serial number or other identifier along with the personal ID information. In addition, the particular device specific identifying information selected may vary from transaction to transaction and may not be known to the user when the information is sent. In one embodiment, the gift exchange server computer asks the mobile device for the particular device specific identifying information. For one offer, the gift exchange server may ask for the device's IMEI number and for another offer, the gift exchange server may ask for the device's serial number. In another embodiment, the application software on the mobile computing device may randomly select a particular device specific identifier to associate with the transaction.

In yet another embodiment, the application software may prompt the user to enter a code, such as the last four digits of their social security number or driver's license number, and this code is combined with a randomly selected device specific identifier that is read from the mobile computing device to form a new code that is sent to the gift card exchange. In this way, the user is required to 1) present the voucher sent from the gift card exchange server and 2) be in possession of the phone with the matching device identifying information associated with the transaction, in order to be properly authenticated and receive the proceeds from the sale of the gift card at the kiosk or other location.

If the voucher code that was sent to the user were to be intercepted by someone other than the owner of the gift card, it is unlikely that the voucher would be presented for payment along with the smart phone having the matching device specific information. Because the system can randomly select different codes for different transactions or offers, the chances that a hacker could supply the gift card exchange server with fabricated data for gift card exchange transactions is lessened.

In one embodiment, the kiosks or merchant's POS devices are equipped with near field communications (NFC) or other wireless circuitry that allows the smart phone and kiosks/POS devices to communicate. Therefore, when the user offers a voucher code to the kiosks to receive funds for a sold gift card, the kiosk/POS can wirelessly query the smart phone for its IMEI number, serial number or other device specific identifier to see if it matches the information that was submitted when the card was sold. The kiosk or POS device may also interact with the mobile computing device to get the user to re-enter the code (e.g. the last four digits of their social security number). This code is then combined with the device specific information that is read from the mobile computing device selected for the transaction to see if the codes match. If all the information matches, then the funds (or other items of value) can be disbursed to the user to complete the card exchange transaction.

Once the funds are received, the transaction is complete. As will be appreciated, the technology disclosed allows a user to sell their gift cards from any location where their mobile computing device can establish a communication link to the gift card exchange server.

Once the user is paid for their gift card, the gift card exchange server 100 can then sell the card value to another user, to a gift card reseller 190, or otherwise dispose of the card or disable the card so that it can't be used by the seller.

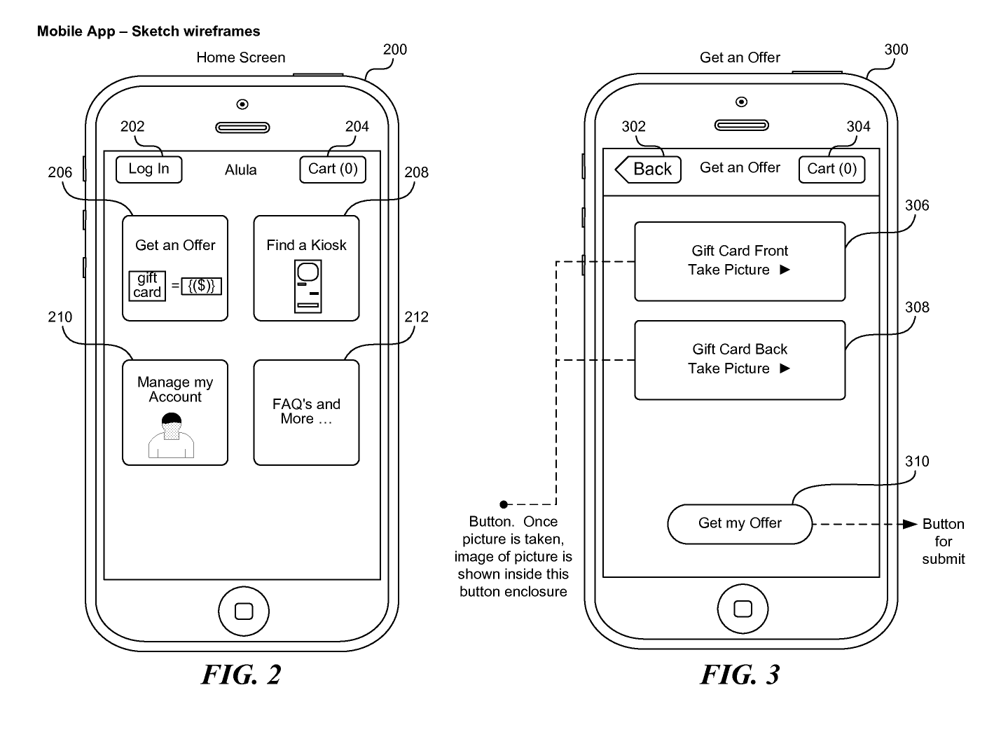

FIGS. 2-15 show a number of representative user interface screens with which a user can interact to enter information about a gift card to be exchanged, and to supply personal ID information in order to prevent fraud on the gift card exchange service. FIG. 2, for example, shows one embodiment of a home screen produced by the application software that is loaded onto the user's mobile communication device to exchange gift cards. In the embodiment shown, the home screen has a log-in button 202, a shopping cart button 204, a “Get an Offer” button 206, and a “Find a Kiosk” button 208. In addition, the user interface screen provides a “Manage My Account” button 210 and a button 212 to view answers to frequently asked questions.

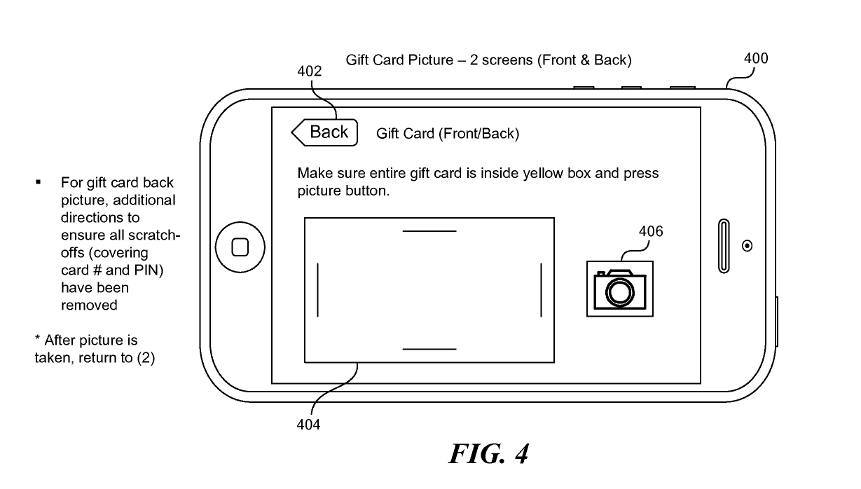

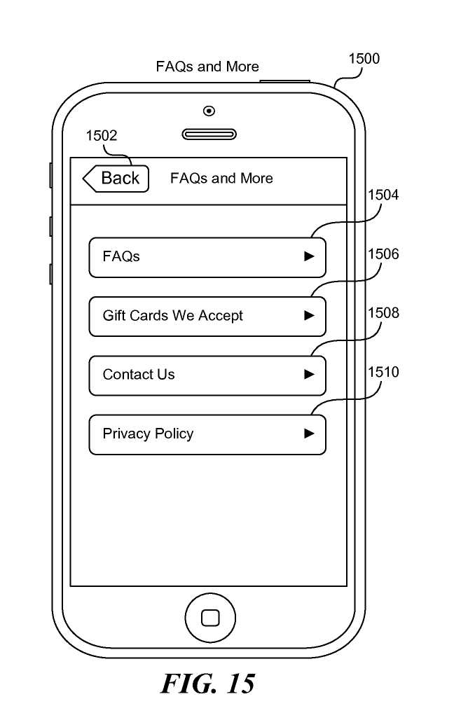

In one embodiment, users are required to open accounts in order to exchange gift cards. This can be accomplished by selection of the button 202, which causes the presentation of user interface screen shown in FIG. 10. Selection of the button 204 causes the presentation of the user interface screen shown in FIG. 6 which allows the user to see and change what is in their shopping cart. Selection of the button 206 starts the process of providing information about a gift card to exchange and causes the application to present user interfaces as shown in FIGS. 3 and 4. Selection of the button 210 allows a user to enter or edit information about their account and causes the application to present a user interface shown in FIG. 12. Finally, selection of the button 212 causes the application program to present a user interface screen as shown in FIG. 15 with which a user can request answers to frequently asked questions or other information from the gift exchange service.

FIG. 3 shows a representative user interface screen that is presented by the application software when the button 206 is selected on the home screen of FIG. 2. The interface screen includes a number of buttons including a “back” button 302 that presents the previously presented user interface screen. Selection of button 304 presents a user interface screen with which a user can check or edit the contents of their shopping cart.

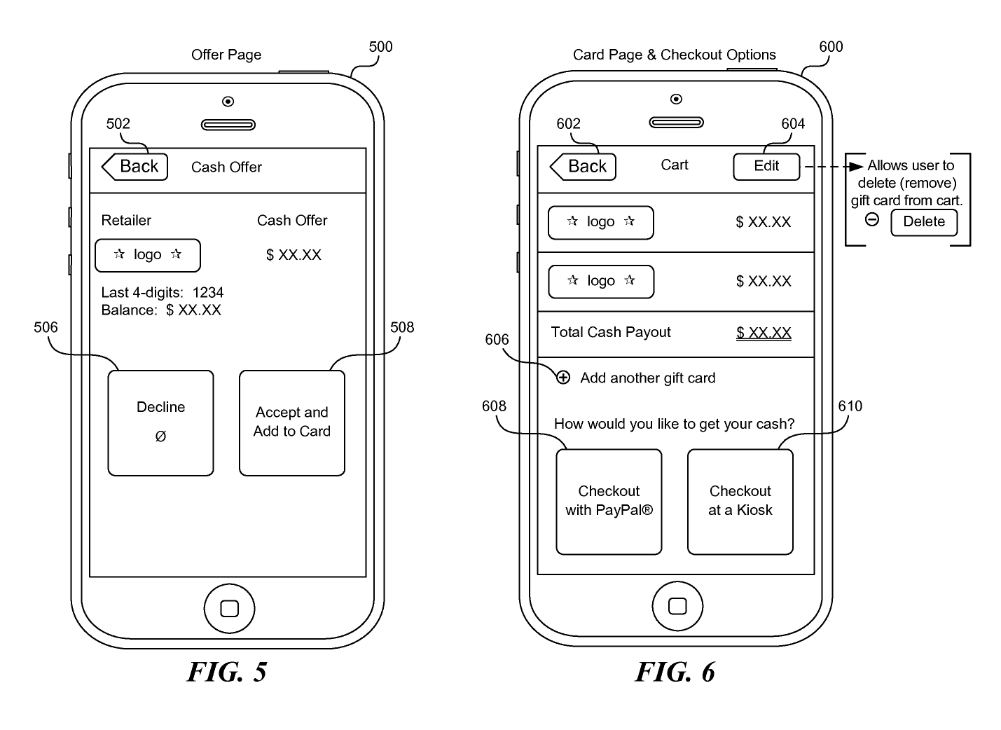

Selection of button 306 causes the application program to present a user interface screen as shown in FIG. 4, with which the user can capture an image of a front of a gift card to be exchanged. Similarly, selection of button 308 also causes the application program to present the user interface screen as shown in FIG. 4, with which a user can capture an image of a back of a gift card to be exchanged. Selection of the button 310 causes the application program to present a user interface in which they are presented with an offer for their gift card, as shown in FIG. 5.

FIG. 4 shows a representative user interface screen in which a user can provide information about a gift card they wish to exchange. The interface screen includes a back button 402 that causes the application program to present the previously shown user interface screen. In addition, the user interface screen 400 includes a viewing box 404 that presents a live screen of the area being imaged by a camera on board the smart phone or other mobile computing device. The viewing box allows the user to place their gift card into an area that is being imaged by the camera. Selecting button 406 causes a camera on the mobile computing device to capture an image of the viewing area.

The same user interface screen shown in FIG. 4 is presented when the user presses the button 308 shown in FIG. 3. In addition, the user interface screen 400 may include written instructions explaining, for example, that all scratch off coverings on the gift card should be rubbed off so that any codes or numbers on the card are visible. Images captured with the user interface screen 400 are saved in memory until the user selects the button 310 shown in FIG. 3 that causes the application program to transmit the images of the card to the gift card exchange server. Upon receipt, the gift card exchange server preferably uses optical character recognition software to convert the received images of the card into alphanumeric data that are used to verify the balance on the card, its issuer or other information.

As will be appreciated, there are other ways of providing information about a card such as entering the information manually using a keyboard or touchscreen on the mobile computing device.

Once the button 310 is selected and the card information has been transmitted to the gift card exchange server 100, the gift card exchange server determines an appropriate offer for the card. The offer is transmitted back to the mobile computing device 160. Upon receipt of the offer information, the application software presents a user interface screen as shown in FIG. 5. The user interface screen 500 includes a back button 502 that causes the application program to present the previously shown user interface screen. The user interface screen 500 presents the terms of the offer, namely the price offered for the gift card to be exchanged. In some embodiments, more than one offer may be shows depending on how the user would like to receive funds. For example, a cash offer may be for one value and an in-store voucher for goods or services may have a different offer value. In addition, the user interface can include some identifying information about the card, such as its last 4 digits of the card number and the issuer. The balance available on the card can also be displayed.

A button 508 allows a user to decline the offer. Upon selecting the button 508, a message is sent by the application software to the gift card exchange server 100 that the offer is declined and the transaction is complete. A button 510 allows a user to accept the offer. Upon selecting the button 510, the application program operates to place the offer price in the user's shopping cart.

When the user presses the button 204 (FIG. 2) or 304 (FIG. 3), the application program presents a user interface screen 600 as shown in FIG. 6. The user interface screen includes a back button 602 that when selected causes the application program to present the previously shown user interface screen. A button 604 allows a user to edit their shopping card by deleting entries. In one embodiment, the user interface screen shows logos for the issuers of each gift card to be exchanged along with the price to be paid for each card and a total for all the cards to be exchanged.

A button 606 is selectable by the user to get an offer for another gift card. Pressing the button 606 causes the application program to present the user interface screen 300 as shown in FIG. 3 so that the user can input information about an additional gift card. The user interface screen also includes a button 608 that asks if the user would like to receive their funds electronically, such as through a PayPal® account. A button 610 asks the user if they would like to receive their funds at a kiosk or other teller.

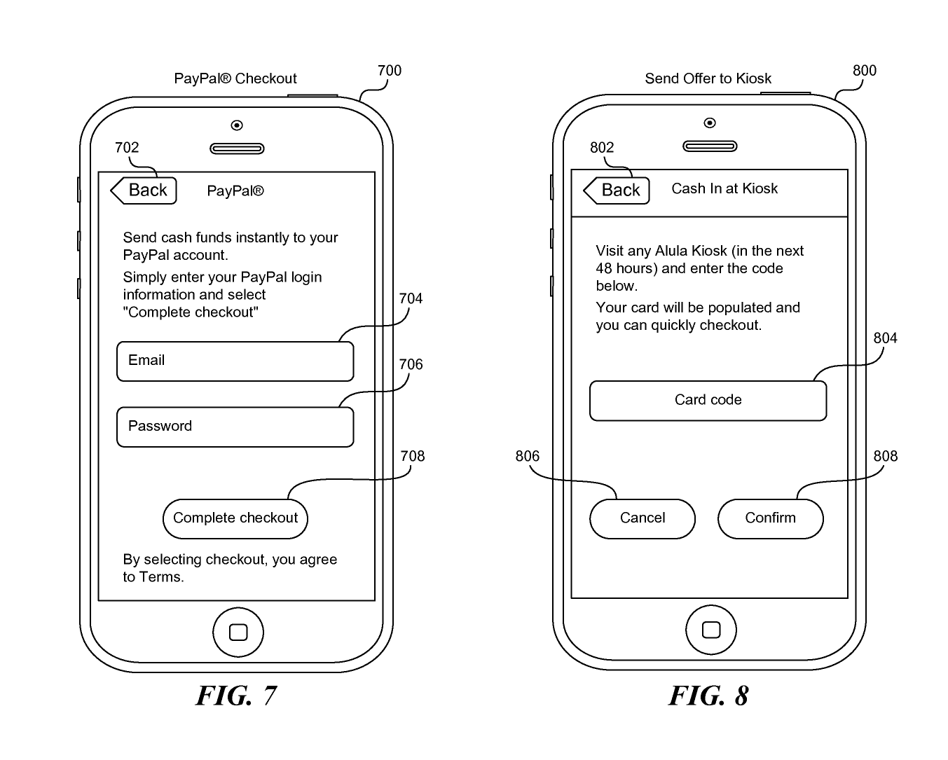

Pressing the button 608 causes the application program to present a user interface screen of the type shown in FIG. 7. The user interface screen 700 as shown in FIG. 7 allows a user to log into their electronic funds transfer account (such as PayPal). The interface screen 700 includes a back button 702 that causes the application program to present the previously presented user interface screen. In addition, the interface screen includes entry fields 704, 706 into which the user enters their account information such as e-mail address, password, etc. A button 708 is selectable by the user to complete the checkout process. Upon selection of the button 708, the application programs forwards the login information to the gift card exchange server that then initiates the transfer of funds to the user's electronic funds account.

If the user selects the button 610 on the shopping cart user interface screen 600, the application program presents a user interface screen 800 of the type shown in FIG. 8. The user interface screen 800 includes a back button 802 that causes the application program to present the previously shown user interface screen. In addition, the interface screen 800 shows a window 804 in which a voucher code that is generated by the gift card exchange server for the transaction is displayed. As discussed above, the voucher code can be a numeric code, an alphanumeric code, a QR code, a bar code or the like which is detectable by a teller, kiosk or other machine that will deliver the funds for the exchanged cards. A button 806 allows a user to cancel the voucher code to indicate that they no longer wish to receive their funds at a kiosk or other location. A button 808 allows the user to confirm that they will use the voucher code to retrieve their funds.

Upon arrival at a kiosk, the user enters the voucher code or presents the voucher code to the electronic detecting device of the kiosk. Software in the kiosk device associates the voucher code with a particular transaction and a determined payout amount. Upon verification of the user's identity, the kiosk can dispense payment (e.g. cash) to the user.

As discussed above, the kiosk's detecting device may interrogate the user's mobile computing device for a device specific identifier that was received in addition to the user's personal ID information. In this way, if the person presenting the voucher code does not possess the mobile computing device with the appropriate device specific identifier, then additional checks of the user's identity may be required or the transaction may be denied.

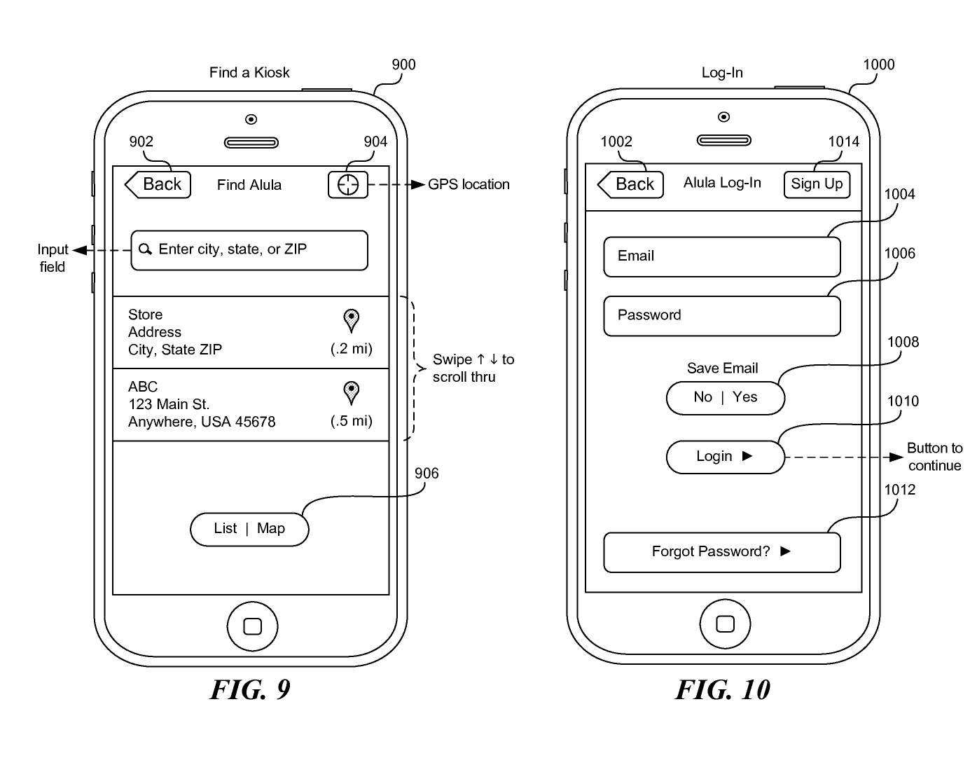

In order to determine the location of the nearest kiosk to the user, the user presses the button 208 on the user interface screen 200 shown in FIG. 2. Upon selection of the button, the application program presents a user interface screen 900 as shown in FIG. 9. The interface screen includes a back button 902 that causes the application program to present the previously presented user interface screen. In addition, the user interface screen includes a button 904 that when selected causes the application program to query an on-board GPS receiver to provide an indication of the location of the mobile computing device. Such information is sent by the application program back to the gift card exchange server computer 100 to match against the known locations of the kiosks. Kiosks or other merchants who can pay the funds owed can be displayed in a list on the user interface and can be sorted by the distance to the user's location. The user interface also includes entry fields into which the user can enter a city, state or zip code that are used by the gift card exchange server to locate kiosks or participating merchants near the location of the user. A button 906 allows a user to toggle the user interface screen between a list of the kiosks/merchants in the area requested and a map showing the location of the matching kiosks/merchants.

As discussed above, the user presses the button 202 shown in FIG. 2 to log-in to their account. Upon pressing the button 202, the application program presents a user interface screen 1000 as shown in FIG. 10. The user interface screen includes a back button 1002 that causes the application program to present the previously presented user interface screen. Entry fields 1004 and 1006 are provided for the user to enter their e-mail address and a password. A button 1008 allows the user to decide if the application program should save a copy of their e-mail address or not. A button 1010 causes the application program to send the information entered into the entry fields 1004 and 1006 to the gift card exchange server for verification. If the user successfully logs in, the application program presents the user interface screen 200 shown in FIG. 2 and the user is allowed to activate the button 206 to enter gift card information and the button 210 to manage their account.

A button 1012 is provided in case the user forgets their password. Selecting the button 1012 causes the application program to send a message to the gift card exchange server that the password has been forgotten. The gift card exchange server can then send a temporary password to the user. Alternatively, an e-mail can be sent to the user to indicate that a new password has been requested and the user should confirm that they would like a new password before sending the temporary password.

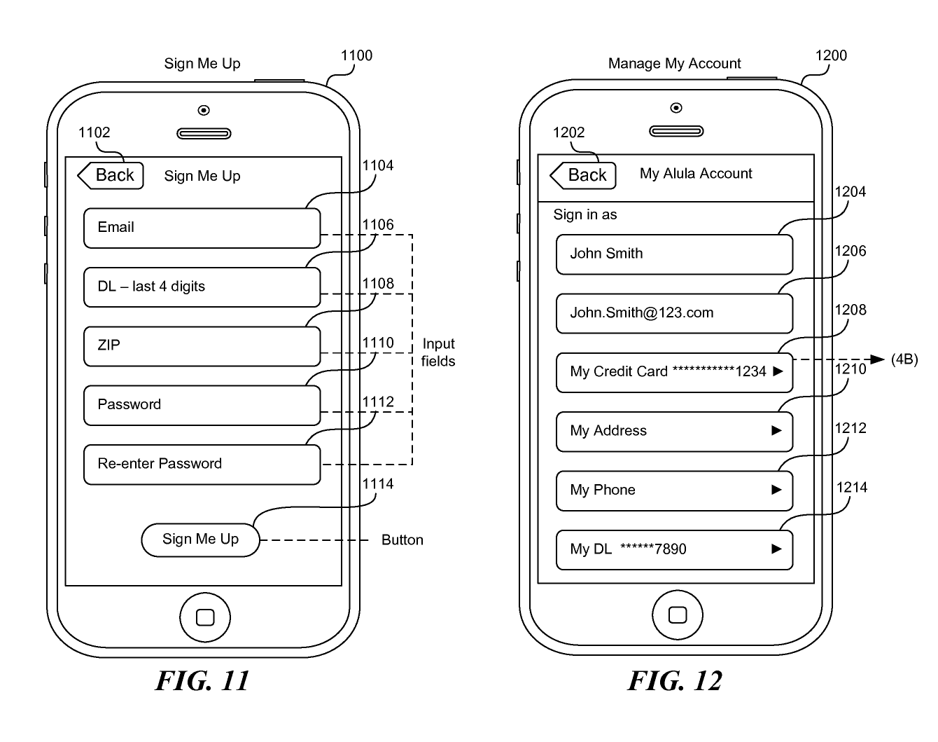

If the user does not have an account, pressing the button 1014 causes the application program to present the user interface screen as shown in FIG. 11. The user interface screen 1100 includes a back button 1102 that causes the application program to present the previously presented user interface. In addition, the user interface screen 1100 includes entry fields 1104, 1106, 1108, 1110, 1112, 1114 where the user can enter identifying information such as, but not limited to, their e-mail address, the last 4 digits of their driver's license number, zip code, password and password confirmation. A button 1114 causes the application program to send the information entered into the entry fields 1104-1112 to the gift card exchange server computer to set up an account for the user. In another embodiment, a user may capture one or more images of their identifying document (front and back of their driver's license, passport etc.) and optical character recognition software operating on the mobile computing device or on the gift card exchange server can fill in the data entry fields based on the data contained in the image(s). Once the account is set up, the user can log into their account using the user interface screen as shown in FIG. 10.

FIG. 12 shows an example of a user interface screen 1200 that is presented when the user selects the “manage my account” button 210 of FIG. 3. The user interface screen 1200 includes a back button 1202 that causes the application program to present the previously presented user interface screen. Text fields 1204 and 1206 show the name and e-mail address associated with the log-in information for the user. In one embodiment, these entries are fixed and cannot be changed in the user interface. Buttons 1208 and 1210 are selectable by the user to bring up user interface screens where the user can edit their credit card information and address. Buttons 1212 and 1214 operate to bring up a keyboard or other input device that can be used by the user to edit their phone number and driver's license or other personal ID information.

Pressing the button 1208 causes the application program to present a user interface screen of the type shown in FIG. 14. The user interface screen 1400 includes back button 1402 that causes the application program to present the previously presented user interface screen. In addition, the user interface screen includes data entry fields 1404, 1406, 1408 and 1410 in which a user can enter the name on their credit card, the card number, the expiration and the security code. A save button 1412 causes the application program to send the information entered into the data entry fields to the gift card exchange server.

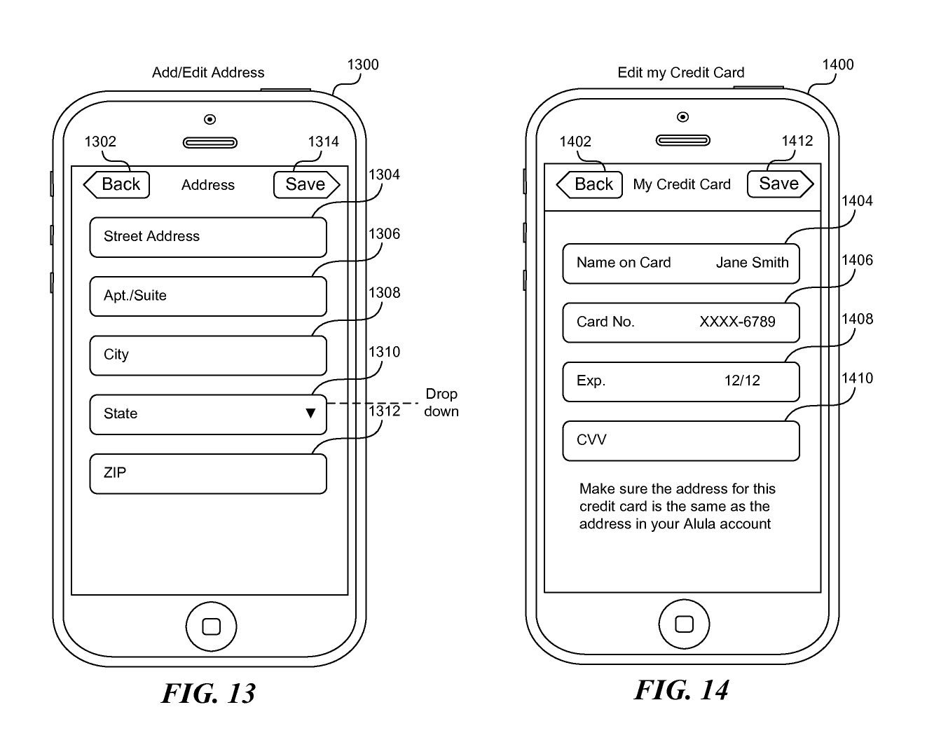

Selection of the button 1210 in the user interface of FIG. 12 causes the application program to present the user interface screen as shown in FIG. 13. The user interface screen includes a back button 1302 that causes the application program to present the previously shown user interface screen. The user interface screen 1300 also includes data entry fields 1304, 1306, 1308, 1310 and 1312 in which the user can enter their street address, apartment or suite number, city, state and zip code respectively. A button 1314 is selectable by the user to cause the application program to send the information added to the data entry fields to the gift card exchange server for storing in association with the user's account.

FIG. 15 shows a representative user interface screen 1500 that contains a number of buttons to direct the user's mobile computing device to display content from web pages that are accessed with a number of buttons. A button 1504 causes the application program to request content for the answers to a number of frequently asked questions. Upon selection of the button 1504, the application program provides a web address to a browser application on the mobile computing device that stores the corresponding content. A button 1506 is selectable to cause the application program to provide a web address to a browser to retrieve content showing the different types of gift cards that can be exchanged. A button 1508 is selectable to cause the application program to provide a web address to a browser program to retrieve content for the address and phone number of the gift card exchange service. Finally, a button 1510 is selectable to cause the application program to provide a web address to a browser program to retrieve content for the privacy policy of the gift card exchange service.

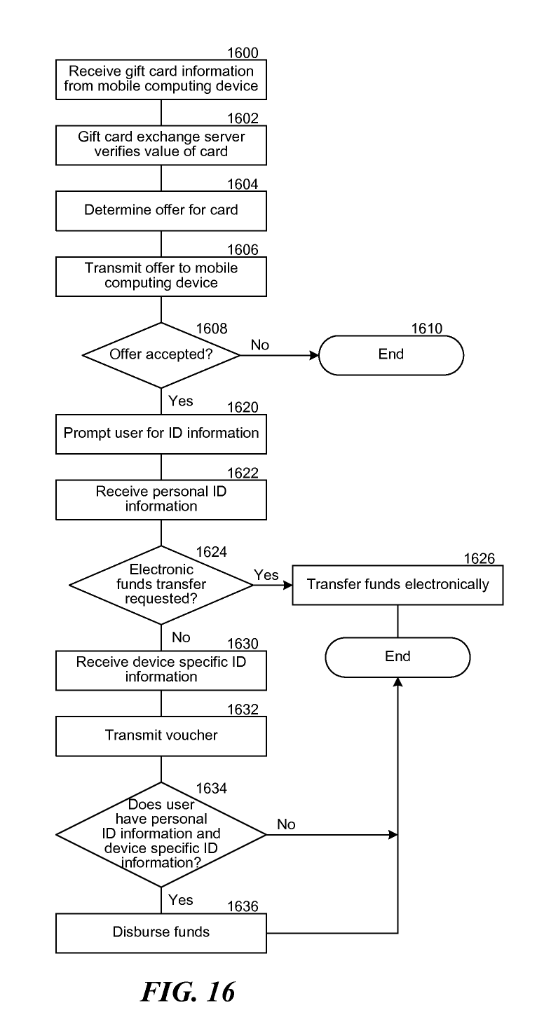

FIG. 16 shows a flowchart of steps performed by a gift card exchange server computer when interacting with a mobile computing device in order to allow a user to exchange a gift card for cash or other consideration. Although the steps in the flowchart are described in a particular order, it will be appreciated that the steps could be performed in a different order or that different steps could be performed to achieve the functionality described.

Beginning at 1600, the gift card exchange server receives gift card information (e.g. a card issuer and value) via a communication link. The gift card exchange server then checks the value of the gift at 1602 such as by looking up the gift card number in a local database or by providing the gift number to a gift card data aggregator or by checking with the merchant who issued the gift card.

Depending on the value that remains on the card, the gift card exchange server determines an appropriate amount to offer at 1604 and transmits the offer terms to the mobile computing device that supplied the gift card information.

At 1608, the gift card exchange server determines if the offer has been accepted. If the seller of the gift card declines the offer, then the transaction ends at 1610.

Assuming that the offer is accepted, the gift card exchange server prompts the user to enter their personal ID information at 1620. As discussed above, this may require asking the user to enter their log in information (e.g. user name and password). Alternatively, ID information such as a driver's license number or a passport number may be requested. The personal ID information is received at 1622. In one embodiment, the gift card exchange server determines if the user is not on a blocked customer list.

In one embodiment, once the offer is accepted, the gift card exchange server operates to cancel or disable the gift card that was purchased by draining the gift card of funds and re-issuing it or informing a gift card data aggregator that the card has been sold etc.

If the gift card exchange service has not designated the user as someone it will not trade with, then the customer is asked if he or she would like to receive funds electronically at 1624. If the user elects to receive funds electronically, then the gift card server authorizes the funds to be delivered at 1626 to a designated account (e.g. PayPal account, bank account, credit card, debit card, e-wallet etc.)

If the user does not want to receive funds electronically, then in one embodiment, the gift card exchange server requests and receives a device specific ID code from the mobile computing device at 1630 and associates the code with the particular offer. Such a code could be the IMEI number of the mobile computing device (smart phone), the serial number of the mobile computing device or another code or number that is either read from the mobile computing device or determined using an input from the mobile computing device.

At 1632, the gift card exchange server transmits a code or voucher to the mobile computing device that can be redeemed for cash or other items of value in order to complete the transaction. When the user attempts to redeem the code or voucher, gift card exchange server (or a kiosk or POS device in communication with the gift card exchange server) verifies that the holder of the code/voucher has both the personal ID information and the device specific ID information that is associated with the offer at 1634. If so, the funds or other item(s) of value associated with the offer are disbursed at 1636. If the holder of the voucher does not possess the required personal ID information and the device specific ID information, the transaction can end at 1640. Alternatively, additional items of ID may be required in order to confirm that the holder of the code/voucher is the user who sold the service the gift card.

As will be appreciated, the disclosed technology offers a way in which a user can at least begin the process of exchanging a gift card from any location where their mobile computing device can establish a communication link to the gift card exchange server. In addition, the gift card exchange server and mobile computing device are programmed to exchange information that serves to further verify the identity of the user so that the likelihood of fraud on the gift card exchange service is lessened.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include any number of clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

In general, the detailed description of embodiments of the described technology is not intended to be exhaustive or to limit the technology to the precise form disclosed above. While specific embodiments of, and examples for, the technology are described above for illustrative purposes, various equivalent modifications are possible within the scope of the described technology, as those skilled in the relevant art will recognize. For example, while processes, blocks, and/or components are presented in a given order, alternative embodiments may perform routines having steps, or employ systems having blocks, in a different order, and some processes or blocks may be deleted, moved, added, subdivided, combined, and/or modified. Each of these processes, blocks, and or components may be implemented in a variety of different ways. Also, while processes, blocks, and or components are at times shown as being performed in series, these processes, blocks, and/or components may instead be performed in parallel, or may be performed at different times.

The teachings of the described technology provided herein can be applied to other systems, not necessarily the system described herein. The elements and acts of the various embodiments described herein can be combined to provide further embodiments.

These and other changes can be made to the described technology in light of the above Detailed Description. While the above description details certain embodiments of the technology and describes the best mode contemplated, no matter how detailed the above appears in text, the described technology can be practiced in many ways. Details of the described technology may vary considerably in its implementation details, while still being encompassed by the technology disclosed herein. As noted above, particular terminology used when describing certain features or aspects of the described technology should not be taken to imply that the terminology is being redefined herein to be restricted to any specific characteristics, features, or aspects of the technology with which that terminology is associated. In general, the terms used in the following claims should not be construed to limit the described technology to the specific embodiments disclosed in the specification, unless the above Detailed Description section explicitly defines such terms. Accordingly, the actual scope of the described technology encompasses not only the disclosed embodiments, but also all equivalent ways of practicing or implementing the described technology.

I/We claim:

1. A method implemented by a gift card exchange server computer, the method comprising:
receiving information about a gift card to be exchanged for value from a mobile computing device;
determining an offer to present for the gift card;
determining if a user accepts the offer;
if the user accepts the offer:
reading device specific identifying information from the user's mobile computing device and associating the device specific identifying information with the offer; and
sending the mobile computing device a voucher for the value of the offer;
when the user attempts to redeem the voucher
querying a mobile computing device presented by the user for the device specific identifying information that had been associated with the offer; and
authorizing the disbursement of funds associated with the offer only if the user presents the mobile computing device having the device specific identifying information associated with the offer.

2. The method of claim 1, wherein the type of device specific identifying information associated with the offer varies from transaction to transaction.

3. The method of claim 1, wherein the type of device specific identifying information is the IMEI of the mobile computing device or its serial number.

4. The method of claim 1, further comprising prompting the user to enter a first code and combining the first code with the device specific identifying information to produce a second code that is associated with the offer.

5. The method of claim 1, wherein the voucher is redeemable at a kiosk or at a point of sale device.

6. At least one tangible, computer-readable medium storing instructions that are executable by a processor of a mobile computing device to allow a user to obtain an offer to exchange a gift card for value, wherein the instructions are executable by the processor to:
capture information about a gift card to be exchanged for value;
transmit the information about the gift card to a remotely located server computer;
receive an offer for the gift card and present the offer on a display screen of the mobile computing device;
detect an acceptance of the offer from a user;
prompt the user to determine if the user would like to receive funds for the offer in one of an electronically accessible account, at a kiosk or at a point of sale terminal;
transmit the user's preference for receiving the funds to the remotely located gift card exchange server; and
receiving a code from the remotely located gift card exchange server if the user's preference is to receive funds for the offer at a kiosk or at a point of sale terminal.

7. The computer-readable medium of claim 6, further comprising instructions that cause the processor in the mobile computing device to:
read device specific identifying information from the mobile computing device; and
transmit the device specific identifying information as a code to be associated with the offer by the remotely located gift exchange server.

8. The computer-readable medium of claim 6, further comprising instructions that cause the processor to:
read device specific identifying information from the mobile computing device;
prompt the user to enter a first code and to combine the first code with the device specific identifying information to produce a second code; and
transmit the second code to the gift exchange server to be associated with the offer.
